(19) United States
(12) Patent Application Publication
(10) Pub. No.: US 2001/0048264 A1
(43) Pub. Date: Dec. 6, 2001

(54) Brushless DC motor having reduced cogging torque

(75) Inventors: Bradley A. Trago, Rockford, IL (US); Richard O. Nelson, Joplin, MO (US)

Correspondence Address: GREER, BURNS & CRAIN, LTD., Suite 2500, 300 South Wacker Drive, Chicago, IL, 60606, US

(73) Assignee: PacSci Motion Control, Inc.

(21) Appl. No.: 09/775,409

(22) Filed: Feb. 1, 2001

Related U.S. Application Data
(60) Provisional application No. 60/178,954, filed on Feb. 1, 2000.

(51) Int. Cl. H02K 1/12

(52) U.S. Cl. 310/254

(57) ABSTRACT

A stator lamination (20) for forming a stator assembly (82) of a permanent magnet motor (80) includes a yoke region (23) and a plurality of stator poles (22) spaced along and extending inwardly from the yoke region. The stator poles (22) are configured and arranged to define a slot (28) having a predetermined span (30) between the lateral end surfaces of adjacent stator poles. A plurality of teeth (24) are formed on the distal ends of each of the stator poles (22), and are separated from each other by a notch (26). The teeth (24) are equi-spaced and the number of notches (26) is an even number.

### TECHNICAL FIELD

The technical field of this invention is brushless, permanent magnet, DC motors, and particularly such motors optimized for use in a vibration sensitive environment.

### BACKGROUND ART

Cogging torque is a problem in high performance brushless, permanent magnet, DC motors. The effect of cogging torque is a periodic torque disturbance caused by the tendency of the rotor poles to align at certain angular positions. The cogging torque can excite resonances causing increased noise and vibration. Cogging torque is most prevalent at low speeds and is a principle source of position and velocity control degradation.

Motor designers use several techniques to reduce cogging torque. It is well known in the art that cogging torque is reduced if the number of stator teeth is not an integer multiple of the number of rotor poles. Increasing the motor air gap will also decrease cogging torque. Skewing the stator slots or rotor magnets is also known to reduce cogging torque. However, increasing the motor air gap or skewing comes at the expense of reducing the motor power output. Additionally, skewing the stator slots makes the motor assembly more complicated and adds further steps to the assembly process, resulting in increased cost of manufacturing. Skewing the permanent magnets used in the rotor adds cost and complexity to the magnets. For high volume production, these extra steps increase production time and production cost.

### BRIEF DESCRIPTION OF THE DRAWINGS

FIG. 1 is a view of an individual stator lamination in accordance with one embodiment of the present invention;

FIG. 2 is an enlarged view of an individual stator lamination taken along section 2-2;

FIG. 3 shows an end-view of a permanent magnet motor;

FIG. 4 is an illustration of cogging torque as a function of rotor angle; and,

FIG. 5 shows an end-view of a permanent magnet motor incorporating the stator laminations of FIG. 1.

### DETAILED DESCRIPTION

The present invention is directed to a permanent magnet motor including a stator assembly having substantially cylindrical yoke region and a plurality of stator poles spaced along and depending inwardly from the yoke region. The stator poles are configured and arranged to define a slot having a predetermined span between the edges or lateral end surfaces of adjacent stator poles. A plurality of teeth are formed on the distal end of each stator pole. The teeth on each stator pole are separated from each other by a notch. The motor also includes a rotor assembly having a plurality of magnets and disposed in an area defined by the distal ends of the stator poles. In accordance with the present invention, the teeth are equi-spaced and the number of notches is an even number.

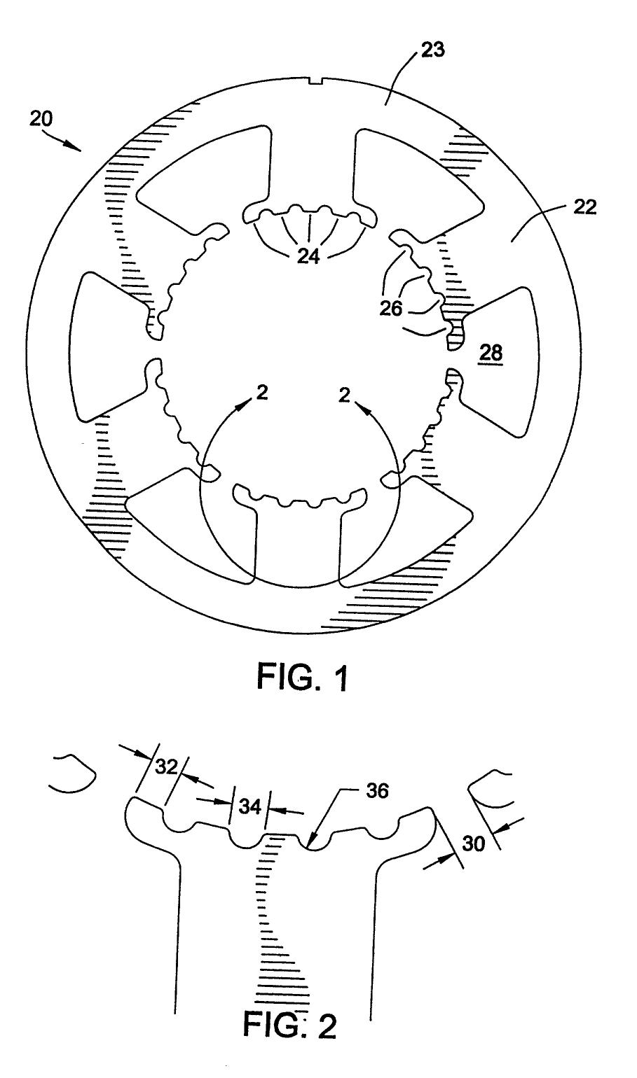

Turning now to the drawings, FIG. 1 shows a view of a stator lamination 20 according to the invention and FIG. 2 shows an enlarged view of a portion of the stator lamination 20. Each lamination 20, which can be formed by stamping, has a series of poles 22 spaced equally and extending inwardly from a generally circular yoke region 23. A plurality of teeth 24 and notches 26 are formed on the distal end (away from the yoke region 23) of each pole 22. The poles 22 are separated by slots 28 which provide an area for receiving the stator (or coil) windings. The radial distance between adjacent stator poles defines a slot span 30. Each tooth 24 has an angular span 32, and each notch 26 has a span 34 and a notch span angular 36.

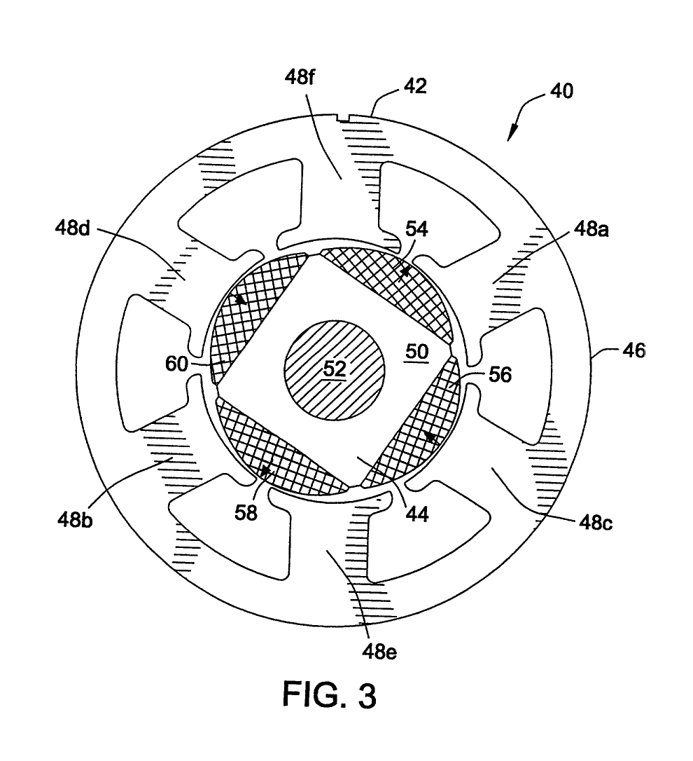

Turning now to FIG. 3, a cross section of a permanent magnet servo motor 40 is shown. The motor 40 has a stator assembly 42 and a rotor assembly 44. The stator assembly 42 comprises a stator lamination stack made of laminations 46 and has stator windings (not shown) wound around stator poles 48a-f. The rotor assembly 44 comprises a rotor lamination stack 50, a shaft 52, and permanent magnets 54, 56, 58, 60. The direction of magnetization of the permanent magnets 54, 56, 58, 60 is indicated by arrows. The permanent magnets 54, 56, 58, 60 are shaped such that the air gaps between the magnets and the stator poles 48a-f varies progressively with respect to angle, for example, from about .024 to .070 inch. The effect of the shape is that the motor air gap is smallest at the center of the magnets 54, 56, 58, 60 and largest at the transition region or gap between the magnets. This aids in reducing cogging torque due to the compound air gap and the motor output power is not significantly reduced.

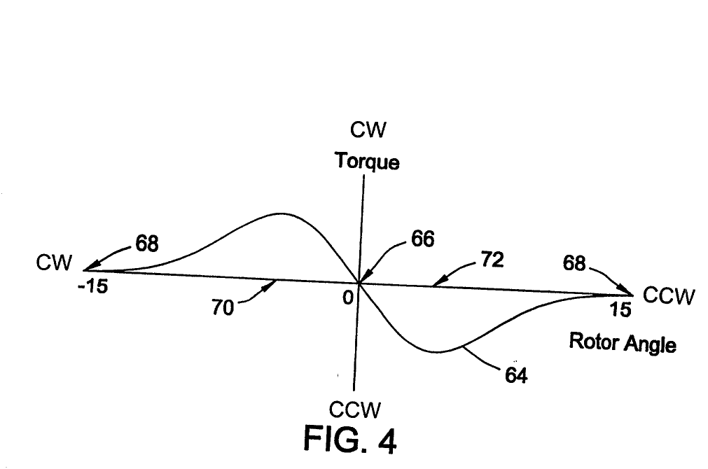

During the rotation of the rotor assembly 44, cogging torque at the stator poles 48 resulting from the interaction of rotor poles created by all of the permanent magnets 54, 56, 58, 60 is at a minimum (and stable) when the center of the rotor poles (i.e., the center of the magnets) are aligned with the center of the stator poles 48, and also when the center of the rotor poles are in an unaligned position with the stator poles (i.e., between two adjacent stator poles). Cogging torque at the stator pole 48 due to a rotor pole is at a maximum when the center of a rotor pole aligns with either of the two edges, or lateral end surfaces, of the stator pole 48. The polarity of the cogging torque due to a rotor pole is positive clockwise (CW) as the rotor pole moves towards an aligned position and is negative counterclockwise (CCW) as the rotor pole moves away from a stable aligned position in a clockwise direction. For a four rotor pole motor with six stator poles, for example, the cogging torque is periodic for every thirty degrees of rotation, with one cycle shown in FIG. 4. In FIG. 4, the cogging torque 64 is shown as a function of rotor angle. The cogging torque is zero at a stable aligned position 68, (12 per revolution) and at an unstable unaligned position 66, (12 per revolution) and is a maximum at the lateral end surfaces 70, 72 of the stator 48.

Turning back to FIG. 3, the rotor assembly 44 is at a position where the rotor pole created by the permanent magnet 54 produces the maximum cogging torque at the stator pole 48a and the rotor pole created by the permanent magnet 58 produces the maximum cogging torque at the stator pole 48b. The rotor pole created by the permanent magnet 56 is near alignment with the stator pole 48c and the resulting cogging torque at the stator pole 48c is near zero. Likewise, the rotor pole created by the permanent magnet 60 is near alignment with the stator pole 48d and the resulting cogging torque at the stator pole 48d is also near zero. The cogging torque at stator poles 48e and 48f is negligible, since the air gap in these areas are relatively large. The net motor cogging torque is the sum of the cogging torque at each stator pole 48 and is a periodic function occurring twelve times per revolution (for a 4-rotor, 6-stator pole motor). This net cogging torque can be reduced when the cogging torque produced as a result of the interaction between one rotor pole and a stator pole 48 is opposed by the cogging torque produced as a result of the interaction between another rotor pole and another stator pole. This is not possible in the motor of FIG. 3 since two rotor poles created by the corresponding two magnets 54, 58 are producing the maximum cogging torque in the same direction, and the other two rotor poles are producing a lower magnitude torque that is not sufficient to offset the cogging torque produced by the magnets 54, 58.

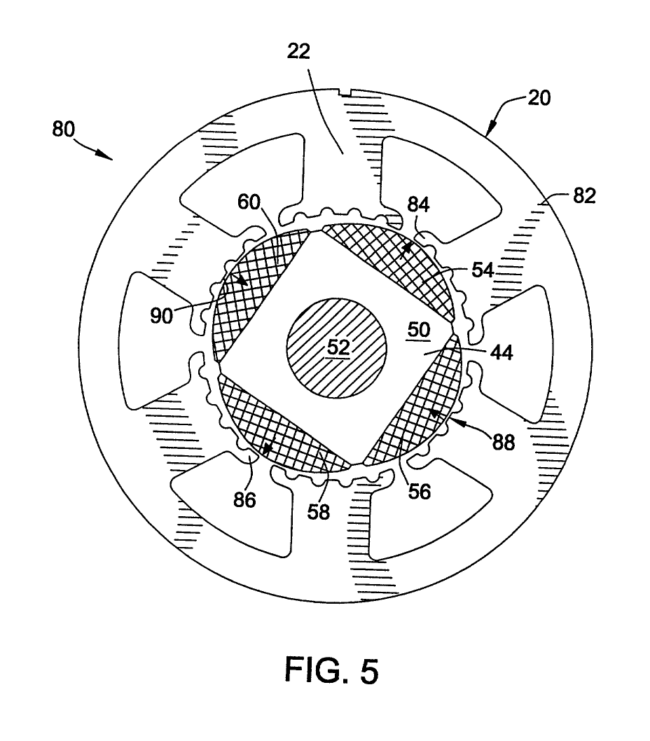

In accordance with the present invention, an offsetting torque is accomplished by placing notches in the stator pole 48. FIG. 5 shows a motor 80 that has a stator assembly 82 and a rotor assembly 44. The stator assembly 82 comprises a stator lamination stack made from the laminations 20 with the stator poles 22 having the teeth 24 and the notches 26 (shown in FIG. 1). Stator windings (not shown) are wound around the stator poles 22. The rotor assembly 44 comprises a rotor lamination stack 50, a shaft 52, and the permanent magnets 54, 56, 58, 60. The direction of magnetization of the permanent magnets 54, 56, 58, 60 is indicated by arrows.

In FIG. 5, the rotor assembly 44 is at a position where the rotor pole created by the permanent magnet 54 produces the maximum positive cogging torque at the tooth 84 and the rotor pole created by the permanent magnet 58 produces the maximum positive cogging torque at a tooth 86. In other words, the center of the rotor pole created by the magnet 54 is aligned with one edge of the tooth 84, and that created by the magnet 58 is aligned with one edge of the tooth 86. The rotor pole created by permanent magnet 56 produces a maximum negative cogging torque at a tooth 88. Likewise, the rotor pole created by the permanent magnet 60 produces a maximum negative cogging torque at tooth 90. The cogging torque due to the interaction of the rotor poles and the remaining teeth 24 not specifically identified produces some either positive or negative torque, depending on the position of the rotor poles in relation to each tooth 24. The net motor cogging torque, however, is reduced due to the teeth 24 introduced on the laminations, which interact with the rotor poles to create an opposing torque to offset the cogging torque.

The theoretical optimum design for reducing the net cogging torque of a class of motors having a stator to rotor pole ratio of 1.5 is to have the stator tooth span 32 and the stator notch span 34 as close or equal to the stator slot span 30. For a 6-stator, 4-rotor pole (6:4) design, for example, with 4 equally spaced notches per tooth, this occurs when the spans are at 6 degrees. In general this technique for such a class of motors requires:

$$\frac{( 360 / s ) - ss}{ss} = 2 n + 1 \qquad ( 1 )$$

where s is the total number of stator poles 22; ss is the slot span 30 and n is the number of notches 26 per stator pole. Furthermore, the number of notches n must be an even number.

When tests were performed on a motor with this design and having a continuous power output of 1.3 HP at 8000 rpm, however, measurements showed that the variability in the cogging torque ranged from 3 in-oz peak-to-peak to 9 in-oz peak-to-peak. It should be noted that this variability can be accounted for in the servo motor control, but it increases the complexity of the controller.

The slot span 30 is a predetermined value selected in part by manufacturing constraints. For example, the slot span 30 should be sufficiently wide as to allow the windings (not shown) to be inserted through the slot span and wound around the stator poles 22. As discussed above, the tooth span 32 and the notch span 34 must be as close to the slot span 30 as possible and also satisfy the parameter of n. Accordingly, it may require a number of iterations to obtain a value of n. Some compromise may be inevitable. Further analysis indicated that allowing the denominator of the left hand side of equation 1 to depart from the value of slot span (SS) marginally can give adequate results. Using equation (1) for a 6:4 motor design with a slot span (SS) of 7.14 degrees for example, with n =4, the variability in the measured cogging torque ranged from 6 in-oz peak-to-peak to 9.4 in-oz peak-to-peak, resulting in a cogging torque ripple of 3.4 in-oz peak-to-peak.

Table 1 below shows test results for a 6:4 design motor with a slot span of 8.07 degrees that has no notches, a 6:4 design motor with a slot span of 6 degrees that has 4 notches, and the same motor with a slot span of 7.14 degrees that has 4 notches. It should be noted that for a motor with no notches, increasing the slot span will decrease the peak-to-peak cogging torque.

TABLE I

| | | |
|---|---|---|
| Measured | | Measured |
| Maximum | | Cogging |
| Cogging | Percent Reduction | Torque |
| Torque peak | in Cogging | Ripple |
| to peak | Torque | peak to peak |
| (in-oz) | (%) | (in-oz) |

| | | | |
|---|---|---|---|
| Motor with no | 16 | — | 2 |
| notches | | | |
| (slot span = 8.07 | | | |
| degrees) | | | |
| Motor with notches | 9 | 43.7 | 6 |
| (slot span = 6 degrees) | | | |
| Motor with notches | 9.4 | 41.2 | 3.4 |
| (slot span = 7.14 | | | |
| degrees) | | | |

Alternatively satisfactory results may be obtained by allowing the notch span 34 to grow marginally at the expense of tooth span 32 so that the notch reluctance presented to the magnets more closely approximates the actual slot reluctance. Optimum dimensions may be determined in any given geometry using magnetic field analysis.

The introduction of notches resulted in a 41 to 43% reduction in cogging torque with no major reduction in voltage or back EMF constant (Ke), torque constant (Kt), resistance, inductance, motor power output, and efficiency. Referring to FIG. 2, it should be noted that the notches 26 between the teeth 24 have the full radius 36 to avoid a sharp transition in the air gap between the rotor poles and the stator poles 22 as the rotor assembly 44 (shown in FIG. 5) is rotated. In this manner, peak-to-peak cogging torque is minimized. In the preferred embodiment, the radius 36 of the notches 26 is one half (½) of the notch span 34. A magnetic field analysis indicates that this ratio provides the best overall reduction in cogging torque.

From the foregoing description, it should be understood that an improved permanent magnet motor has been shown and described which has many desirable attributes and advantages. Each stator pole has teeth that enable generation of torque that offsets torque generated in an opposite direction to reduce the total cogging torque of the motor.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

1. A permanent magnet motor comprising:
a stator assembly having a substantially cylindrical yoke region and a plurality of stator poles spaced along and extending inwardly from said yoke region, said stator poles being configured and arranged to define a slot having a predetermined span between lateral end surfaces of adjacent said stator poles;
a plurality of teeth formed on distal ends of said stator poles, said teeth on each said stator pole being separated from each other by a notch; and
a rotor assembly having a plurality of magnets and disposed in a substantially cylindrical area defined by said distal ends of said stator poles;
wherein the notches are equally spaced and the number of notches per tooth is even.

2. The motor as defined in claim 1 wherein the number of said plurality of stator poles is equal to 1.5 times said plurality of magnets.

3. The motor as defined in claim 2 wherein a span of each of said teeth is substantially equally to a span of each of the notches and also equal to a predetermined span of said slots.

4. The motor as defined in claim 3 wherein the total number of equally spaced notches per stator pole is
$$\frac{( 360 / s ) - ss}{ss} = 2 n + 1$$
where said s is the total number of said stator poles, said ss is said predetermined span of said slots, and said n is the total number of equally spaced notches per stator pole and n is an even number.

5. The motor as defined in any one of claims 1-4 whereby the span of said teeth is substantially equal to the span of said notches but is less than said slot span (SS) such that a nearest even integer solution for n is obtained.

6. The motor as defined in any one of claims 1-4 whereby the notch span is marginally enlarged at the expense of the tooth span in order to optimize the reduction in cogging torque.

7. The motor as defined in claim 2 wherein said magnets are shaped such that an air gap between any one of said magnets and any one of said stator pole varies as said rotor assembly is rotated.

8. The motor as defined in claim 7 wherein said magnets are shaped such that a lateral center of each said magnet is higher than lateral ends of said magnet

9. The motor as defined in claim 1 wherein said notches have a radius that is substantially half of said span of said notches.
